(19) United States
(12) Patent Application Publication
(10) Pub. No.: US 2011/0262780 A1
(43) Pub. Date: Oct. 27, 2011

(54) Whole House Backyard Battery

(75) Inventor: George Barry Cohen, Ocala, FL (US)

(73) Assignee: George Barry Cohen, Ocala, FL (US)

(21) Appl. No.: 13/045,627

(22) Filed: May 23, 2011

Related U.S. Application Data
(60) Provisional application No. 61/313,314, filed on Mar. 12, 2010.

(51) Int. Cl. H01M 10/42; H01M 2/10; H01M 10/48

(52) U.S. Cl. 429/49; 429/122; 429/72; 429/90; 429/96; 429/61

(57) ABSTRACT

A battery device that sits in an underground “box” that would be situated in the ground and would be vastly larger than many car batteries put together. It would be 3 feet wide, 1 to 3 feet deep and up to 12 feet long and would be built on site. The battery would be composed of individual super cells 3 feet wide, 1 to 3 feet deep and 1 foot long. Each super cell can be individually replaced for recycling and repair. The battery would be comprised of cells made of the best materials available according to the technology (lithium ion, etc.) available and whatever patent associated with that technology. At this time, wet lead acid technology as used in conventional auto type batteries are described in this device. This battery would allow for a huge power source for the home or whatever application it would be used for.

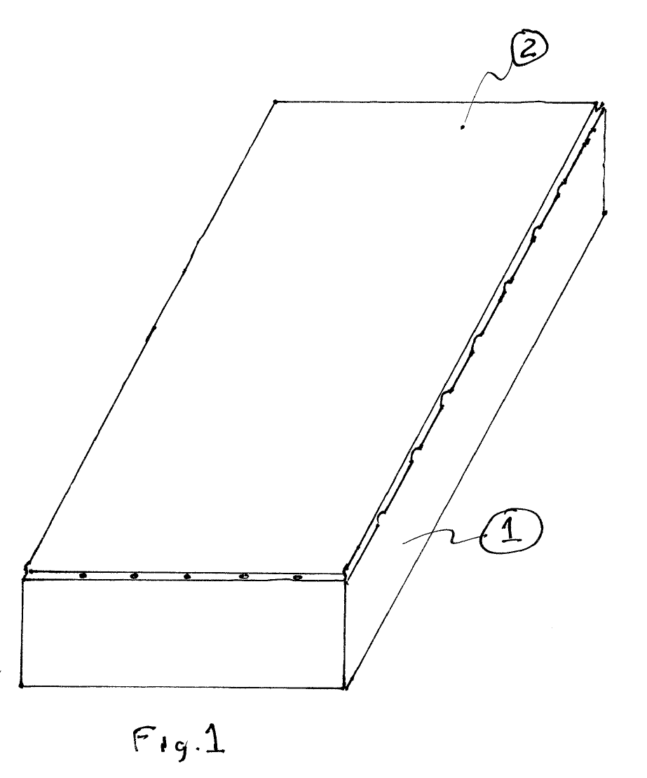

The back Yard Battery (BYB)(FIG. 1)(1), shown with the cover (2) attached, is designed to be buried in the ground. The BYB is meant to be buried so that either the cover (2) alone or sod on top of the cover or other suitable mulch can be put over the top of the BYB cover for esthetic reasons.

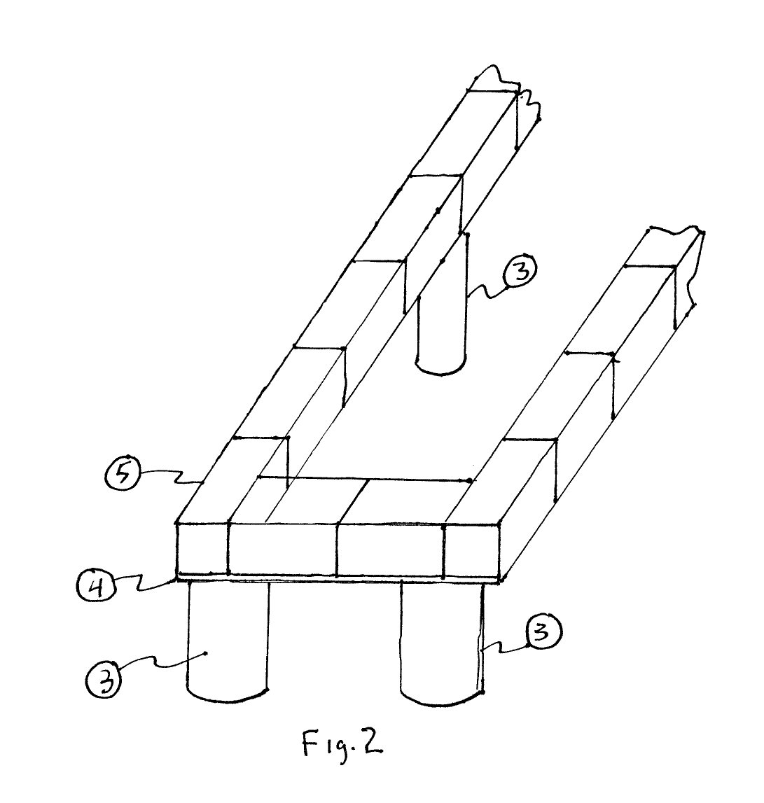

The BYB will be of considerable weight and must be installed on a supporting structure (FIG. 2) that will provide stability in all climates. This means that the foundation will be mounted on Sona Tubes (or equivalent) (3) that are drilled to below the frost line. When the SonaTubes are poured and leveled, a foundation board (4) will be attached to the top of the tubes. The composition of this board is to be determined. It could be marine grade plywood or a suitable acid proof plastic. If the depth of the frost line is too deep to allow for proper orientation of the top of the BYB, concrete blocks (5) may be used to adjust the level of the final BYB height. Otherwise, the BYB may be mounted directly on the foundation board (4). In order to prevent possible ground contamination, a suitable membrane may be placed over the foundation board (4) between it and the BYB. This membrane could then be installed so that it comes up the side of the BYB and is between the BYB and the backfill and would thus, contain any spill from the BYB.

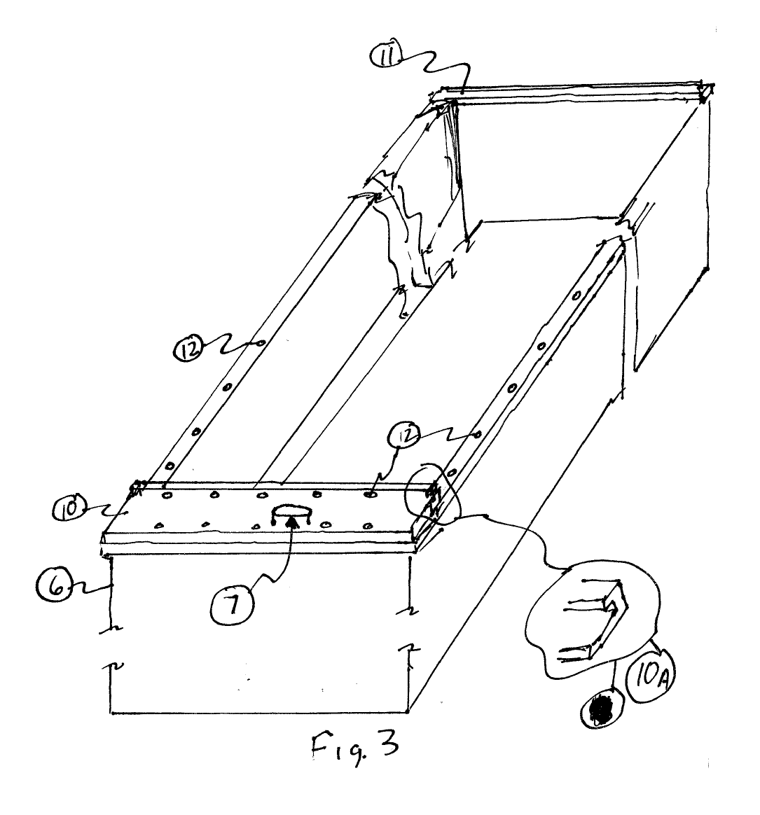

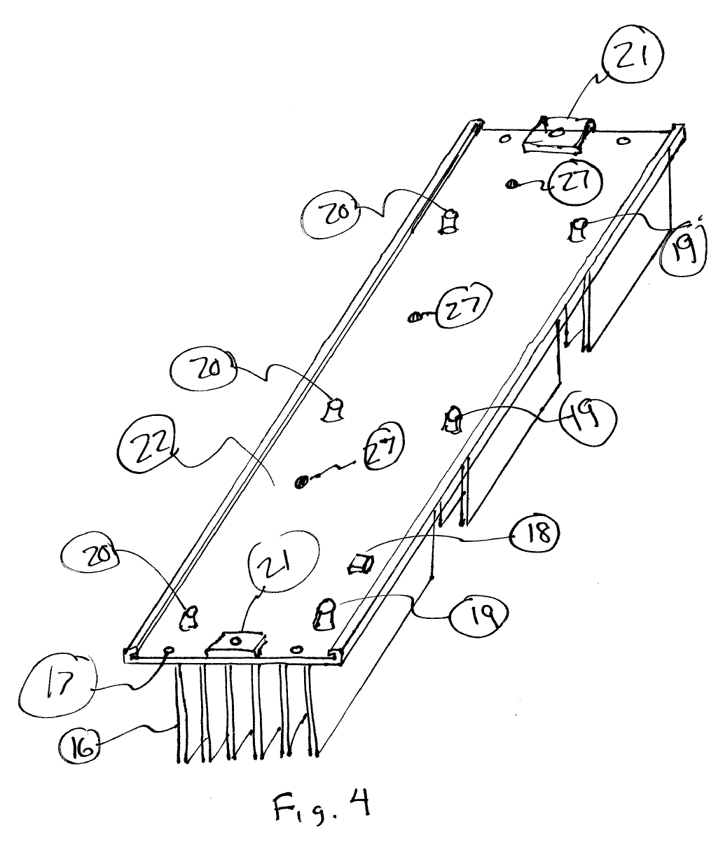

The BYB is comprised of a Battery Tray (FIG. 3). This tray (6) is composed of a suitable material, such of that of common sealed lead acid batteries. The tray can be made of different heights and lengths. It can be as small as one foot high, three feet wide and 1 foot long. This can hold a single, one foot high Super Cell (FIG. 4). Or it can be up to three feet deep, three feet wide and twelve feet long. This can hold twelve, three feet deep Super Cells. The size of the BYB will depend upon the power requirements of the site.

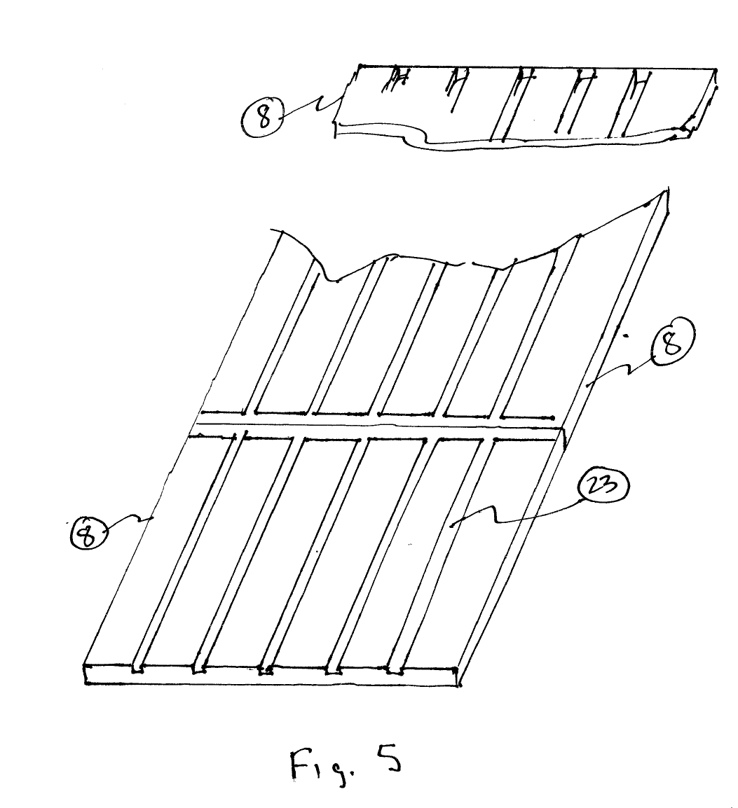

The tray will have a sealing filler opening (7) that will allow for safe filling of acid to the tray when installing the BYB. (Note: all installation and maintenance must be done by certified, trained personnel.) The trays bottom will be lined with Grid Receivers (FIG. 5). The Grid Receiver (8) is three feet by one foot and is glued to the bottom of the tray. There will be one grid receiver for each foot in length.

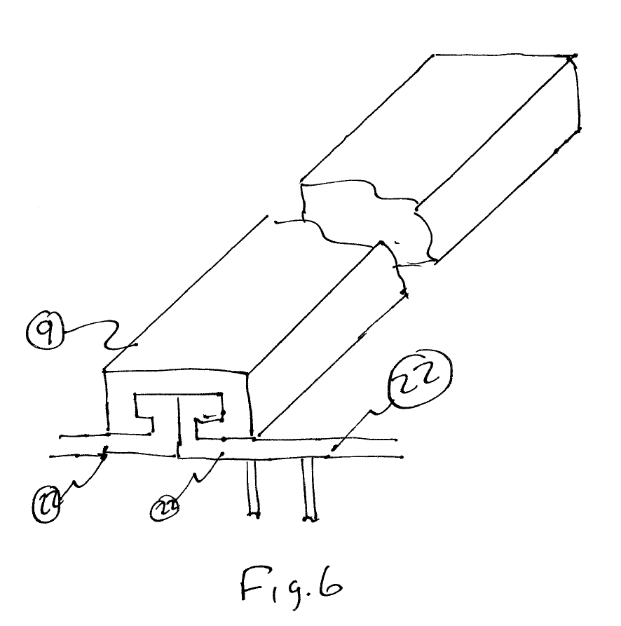

The end'cap of the tray (10) with the filler opening will have a reverse squared C shape edge (FIG. 3) (10A) that will be used to attach the leading edge of the first Super Cell (FIG. 4) (22) by using a slide on Cell Retainer (FIG. 6) (9). The purpose of the retainer is to provide a water tight seal between each Super Cell. The trailing side of the tray will have a similar end cap (11) with the same squared C to attach the trailing side of the Super Cell.

The tray will have embedded nuts (12) to attach the end caps and the Super Cells (22) to the tray to provide a leak proof connection. The embedded nuts will be made of a suitable acid proof material.

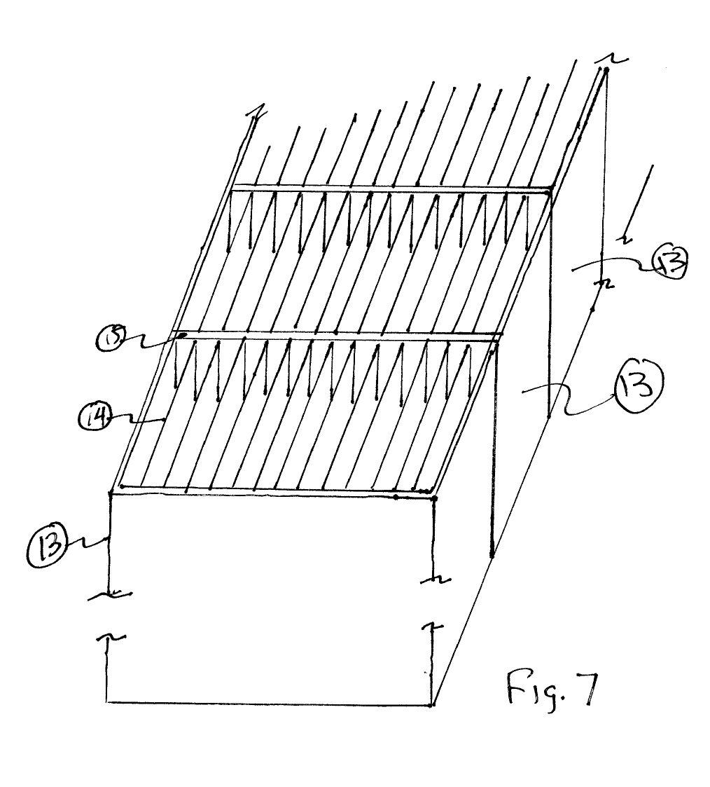

Once the end caps are installed and the tray is properly installed on site and the grid retainers have been installed and allowed to dry, the tray will be filled with filtered water to a specified level. Then acid will be added to the proper specific gravity. After this is done, the Grid Separator Assy. (FIG. 7) (13) is carefully installed, again by trained, certified installer/maintainers. There will be one separator assy. for each Super Cell. The separator (13) will insert snugly into the grid receiver slots (FIG. 5) (23) and form a water resistant seal. This will provide for individual cell integrity. (Note, the number of individual cell separators (14) shown in FIG. 7 is not accurate for the number of actual cells) It is shown for illustrative purposes. The grid separator assemblies butt up to each other (15) but are not glued.

Once all the grid separator assemblies are in place, the individual Super Cells (FIG. 4) are then mounted in place. There are handles (21) to help place the Super Cell into the tray. The Super Cell plates (16) are inserted into the grid separators and the Super Cell is fastened with acid proof bolts through holes (17). Then the cell retainer is slid onto the leading edge of the first cell. If this is the only Super Cell, the trailing end cap is installed and the trailing cell retainer is slid on, sealing the entire BYB. If there are more Super Cells to be installed, the process of installing the Super Cell is performed and the cell retainer is slid on to connect each Super Cell until the last Super Cell is reached and the cell retainer (9) is installed.

Once all the Super Cells have been installed, the electrical connections are performed. On each Super Cell (FIG. 4), there are essentially three individual batteries. Each battery is a nominal 12.5 volts. They may be hooked up in any desired manner (series or parallel) using the anode (19) and cathode (20) posts to achieve the appropriate voltage for the DC to AC converters used at the site. Connector (18) provides internal sensor information about the voltage and temperature of each individual battery in the Super Cell (and other information deemed necessary). This information is to be used by whatever control system is built to charge and monitor the BYB.

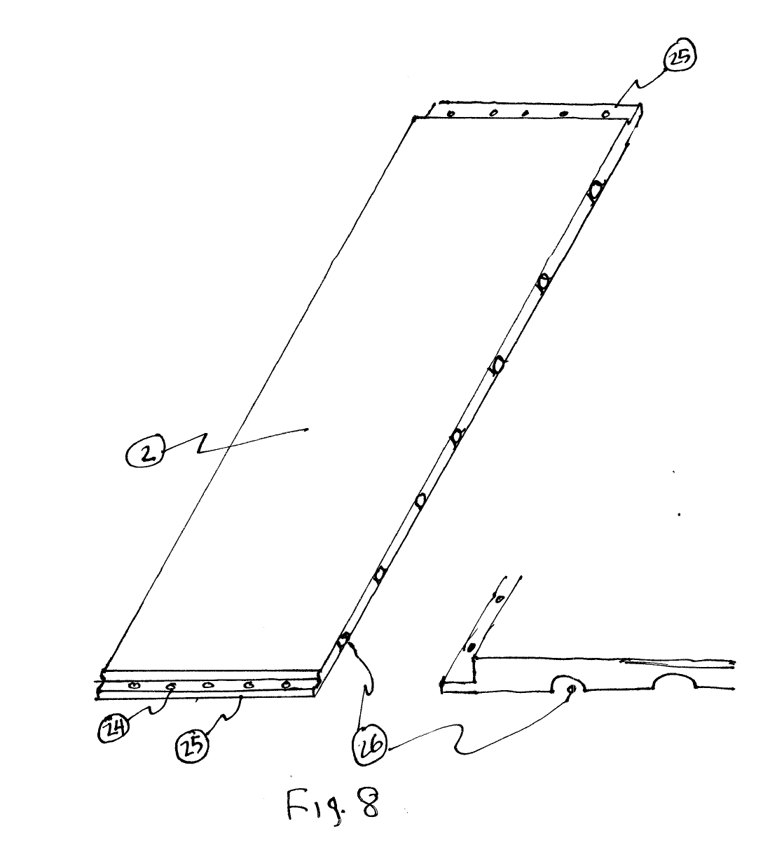

Once the wiring is done and the BYB is tested and works within normal parameters, the BYB is ready to have the cover (FIG. 8) (2) installed. The cover is attached with acid proof bolts through holes (24) on end lips (25) into the tray (FIG. 3) (6). The wiring is designed to pass through cutouts in the cover (26) to provide an esthetically pleasing appearance.

Since the Super Cells are designed to vent in the case of extreme pressure buildup (FIG. 4) (27), the cover should not be air tight and thus, allow for pressure relief.

Note also that the design of the plates and connecting architecture of the Super Cells have not been specified. This will be decided at the time of design testing and may use an existing (patented) design (of others) as appropriate.

Also, while the BYB is intended to be used inconspicuously in people's homes, buried in the back yards, etc., it could also be used in industrial sites. The BYB tray (FIG. 3) would have to be built to hold the electrolyte without the support of being buried or it could be mounted in a concrete bunker, etc.

### NUMBERED ITEMS

1—Back Yard Battery (BYB)

2—BYB Cover

3—Sona Tubes (or equivalent)

4—Foundation Board

5—Concrete Blocks

6—BYB Tray

7—Filler pipe

8—Grid Separator receiver

9—Cell Retainer

10—Leading Tray end cap

11—Trailing tray end cap

12—Embedded acid proof nuts

13—Grid Separator Assembly

14—Grid Separator plates

15—Grid Separator abutment points

16—Super Cell plates

17—Super Cell mounting holes

18—Sensor connector

19—Super Cell Anode connections

20—Super Cell Cathode connections

21—Super Cell Handles

22—Super Cell

23—Grid Receiver Slot

24—BYB Cover mounting holes

25—BYB Cover mounting lip

26—26 BYB Cover cutouts for wiring

27—Super Cell venting holes

1. Where most batteries are made of a standard size, usually for vehicles, arranging them in an array that would provide the same capacity of this proposed battery would be far less efficient than the proposed battery. The proposed battery is 3 feet wide by 1 to 3 feet deep by 1 foot up to 12 feet long in size and would provide up to 108 cubic feet of battery density with a footprint of up to 36 square feet. This would be at ground level and placed in the backyard of the house it would be supplying power to. In order to get the same volume density using individual current style batteries, they would have to be arranged in a rack, above ground to achieve the same foot print. To protect this battery array, you would have to build a shed, which is far more difficult than this proposal.
This proposed battery is designed to be covered, perhaps by artificial grass and be unobtrusive or it could be located under a solar array.

2. This battery is designed to be installed and maintained by trained and licensed personnel.

3. Most standard sealed lead acid batteries are very heavy, due in a large measure to the weight of the electrolyte. The shipping charges for these batteries include the weight of the electrolyte. Supplying enough standard batteries to match the power density of this proposed battery would be very expensive to ship. Since this proposed battery is filled on site with a hose (through a filter) directly into the battery, the shipping weights of the proposed battery will be far less than standard batteries.

4. A grid receiver will be glued to the bottom of the tray. The grid receiver plate will provide a leak resistant seal for the separator grid.

5. The electrolyte will be added on site by filling the tray to the proper level and adding concentrated acid.

6. After the acid and water have been added and mixed, a separator grid will be placed in the tray. The grid will fit into the grid receiver.

7. The cell will then be placed into the tray and the plates will be inserted into the grid, making individual 2.1 volt cells for a total of three 12.5 volt batteries in one Super Cell.

8. The acid will be transported in special containers that will allow for spill-less transfer of the acid to the battery tray through a special connector.

9. In the case of electrolyte contamination, the acid will be neutralized and the contents pumped out and replaced with fresh water and acid. All done on site by licensed personnel.

10. The cells of the battery are designed to be replaced when they go bad. This is done on site by trained personnel.

11. The cells will be transported to a repair depot in special plastic containers that seal and contain any possible electrolyte leakage

12. The repair depot will recycle the damaged plates and repair the cell using recycled materials whenever possible.

13. The battery will have smart technology that can sense when individual cells go bad. It can also sense temperature and other items, such as the pressure in the battery. All information from the sensors will be provided to a control/report unit in the house.

14. This control unit will work with charging and power conversion devices to provide a safe and efficient system. In the event that the battery is fully charged, the excess power would be diverted back to the commercial power grid.

15. The control unit would also be integrated with the power conversion devices so that the battery would not be used to the point where it become undercharged and threaten the batteries health.

16. The battery is comprised of cells mounted in a tray. The number of cells and the depth of the cells determine the tray size. The tray will be three feet wide and range from one to three feet deep and one to 12 feet in length.

17. The tray will be installed in the ground by professionally trained and licensed personnel.

18. The installation will be in a bunker built in a manner sufficient to hold the battery and not be affected by freezing ground. Supports to below the frost line shall be built and the battery will rest on these supports. The supports will be concrete filled cement in sona-tubes or equivalent devices.

19. The battery will be water tight and will resist damage by floods. This will also prevent the contamination of the local area by the acid electrolyte in the case of a flood.

20. The size of the battery (or number of batteries) will be determined by the power consumption of the house and the amount of time the battery(s) will supply power to that house.

21. The purpose of the battery is to supply power to a house in the event of a power failure

22. Another purpose of the battery is to store energy created at the house by such powers sources as wind turbine, solar or hydro-electric, etc.

23. Another purpose is to provide a method of recharging electrically powered vehicles.

24. The high current availability could/would provide a far faster charging system then the power from the wall socket.

25. The battery will be built with appropriate current limiting devices (fuses) that will protect the battery from overheating due to external short circuits. These devices can be built into the power connections made at the batteries terminal.

26. The battery will have the ability to be connected in a variety of voltage.

27. Each cell will effectively be three batteries and can be connected in series or parallel to provide 12, 24 or 36 volts at each cell. The cells can then be connected on any manner to provide any combination of voltages and current to match the requirements of the house it will be supplying power to.

28. In the event that the battery cannot be fully charged by locally supplied energy sources (solar, wind, etc) , it can be set to charge at off-peak hours by commercially supplied power.
